(19) United States
(12) Patent Application Publication
(10) Pub. No.: US 2022/0143827 A1
(43) Pub. Date: May 12, 2022

(54) Orientation Angle Display During the Manual Guidance of a Robot Manipulator

(71) Applicant: FRANKA EMIKA GMBH, München (DE)

(72) Inventors: Tim Rokahr, München (DE); Andreas Spenninger, Karlsfeld (DE)

(21) Appl. No.: 17/440,322

(22) PCT Filed: Mar. 19, 2020
(86) PCT No.: PCT/EP2020/057563

§ 371 Date: Sep. 17, 2021

(30) Foreign Application Priority Data
Mar. 28, 2019 (DE) 10 2019 107 969.1

(51) Int. Cl. B25J 9/16; B25J 13/08

(52) U.S. Cl. CPC B25J 9/1653; B25J 13/088; B25J 9/161

(57) ABSTRACT

A robot system with a robot manipulator and with a visual output unit, wherein the robot manipulator includes a robot link and the robot link includes an inertial measuring unit, wherein the inertial measuring unit is designed to determine a direction of a gravity vector when the robot link is immobile, and to determine, over a plurality of points in time, a current orientation of the robot link in relation to the gravity vector using attitude gyros, and to transmit, to the visual output unit, the current orientation of the robot link in relation to the gravity vector, and wherein the visual output unit is designed to display the current orientation of the robot link in relation to the gravity vector.

### CROSS-REFERENCE TO RELATED APPLICATIONS

The present application is the U.S. National Phase of PCT/EP2020/057563, filed on 19 Mar. 2020, which claims priority to German Patent Application No. 10 2019 107 969.1, filed on 28 Mar. 2019, the entire contents of which are incorporated herein by reference.

### FIELD

The invention relates to a robot system with a robot manipulator and with a visual output unit, as well as to a method for outputting a current orientation of a robot link of a robot manipulator in relation to the gravity vector on a visual output unit.

### SUMMARY

The aim of the invention is to improve the manual guidance of a robot manipulator in that, during the manual guidance, the user can orient the robot link of a robot manipulator more precisely in terms of its orientation.

The invention results from the features of the independent claims. Advantageous developments and embodiments are the subject matter of the dependent claims.

A first aspect of the invention relates to a robot system with a robot manipulator and with a visual output unit, wherein the robot manipulator includes a robot link and the robot link includes an inertial measuring unit, wherein the inertial measuring unit is designed to determine the direction of a gravity vector when the robot link is immobile, and to determine, over a plurality of points in time, a current orientation of the robot link in relation to the gravity vector using attitude gyros, and to transmit, to the visual output unit, the current orientation of the robot link in relation to the gravity vector, and wherein the visual output unit is designed to display the current orientation of the robot link in relation to the gravity vector.

Preferably, the robot link is an end effector, wherein the end effector is arranged on a distal end of the robot manipulator and the end effector includes the inertial measuring unit.

An inertial measuring unit is, in particular, a measuring unit which, using inertia, acquires kinematic data. In particular, accelerations of acceleration sensors can be acquired by the inertial measuring unit and orientations between a housing of the inertial measuring unit and attitude gyros can be determined.

An orientation of the robot link is preferably expressed by orientation angles, preferably Euler angles, or alternatively preferably by quaternions, in relation to an earth-fixed coordinate system. The orientation of the robot link is therefore independent of the position of the robot link in relation to the earth-fixed coordinate system.

The gravity vector is the vector of the pull of gravity locally on the robot manipulator and is characterized by an amount expressing acceleration and constant in time and by a direction.

The visual output unit is designed in particular to display the current orientation of the robot link in relation to the gravity vector in real time in relation to, and in particular simultaneously with, the determination of the orientation of the robot link.

The term ‘real time” is an established term from computer technology and neglects inevitable latencies, since infinitely short computation times are naturally not possible. Therefore, the term “real time” is understood to mean an approximately simultaneous process execution, wherein the dead times and latencies between the processes (in the concrete case the processes are the acquisition of the current orientation of the robot link in relation to the gravity vector and the display of this orientation) are far below the human threshold of perception. Thus, advantageously, the orientation of the robot link in relation to the gravity vector is displayed to the user almost at exactly the same time as it is determined. The determination of the current orientation of the robot link in relation to the gravity vector in this sense occurs in real time, that is to say, with only negligible latencies. The same applies to the term “simultaneously.”

An advantageous effect of the invention is that the user is provided with feedback as to the orientation in which the robot link of the robot manipulator is in relation to the gravity vector. In contrast to a water level, the attitude gyros make it possible, even in the case of an accelerated movement of the robot link or of the inertial measuring unit, to determine the correct orientation of the robot link in relation to the gravity vector independently of the state of motion of the attitude gyro. A water level, in contrast, would react to an acceleration caused by a motion tangential to the water line. In contrast, if the direction of the gravity vector is determined when the robot link is immobile, no other interfering acceleration is erroneously acquired, in particular, by acceleration sensors. Here, the attitude gyros with stable orientation angle can then also advantageously determine the current orientation of the robot link in relation to the gravity vector, when there is an acceleration due to motion of the robot link, for example, a Coriolis acceleration or a centrifugal acceleration.

According to an advantageous embodiment, the attitude gyros are mechanical, rotating gyros. Rotating mechanical gyros are in particular gimbal-mounted and rotate with relatively high speed of rotation. The higher the speed of rotation, the more intensively the attitude gyro stability works, which results in the mechanical gyros remaining in their original orientation even if the housing in which the gyros are gimbal-mounted is modified in its orientation in relation to the earth. The mechanical gyros therefore have a stable orientation angle, so that, by the relative orientation of the housing of the inertial measuring unit in relation to the positionally stable gyros, a relative orientation of the inertial measuring unit and thus also a relative orientation of the robot link in relation to the gravity vector can always be determined, since the inertial measuring unit is arranged stationary on the robot link and the direction of the gravity vector is determined according to the first aspect of the invention.

According to an additional advantageous embodiment, the attitude gyros are optical gyros. Optical gyros include, in particular, a ring made of a light conducting material, in particular glass fibers. Using the fact that the speed of light is always constant, it is possible to derive, from the time period of a rotation of, in particular, a laser beam in the light conducting ring, a relative change of orientation of the optical gyro, wherefrom a current orientation of the optical gyro in relation to its starting orientation can be determined. The optical gyro and a mechanical gyro therefore have the same function, although the information on the orientation of the inertial measuring unit is generated via a starting orientation using other technical means.

According to an additional advantageous embodiment, the visual output unit includes a first display element and a second display element, wherein a shift between the first display element and the second display element, a rotation between the first display element and the second display element, or the shift and the rotation correlates with at least one angle about a respective axis according to the relative orientation of the robot link in relation to the gravity vector.

Preferably, the respective axis is stationary in relation to the robot link.

According to an additional advantageous embodiment, the visual display unit includes a first display element and a second display element, wherein a first angle of the first display element in relation to the second display element correlates, at each of the plurality of points in time, with an angle about a first axis according to the relative orientation of the robot link in relation to the gravity vector.

In the simplest case, the first display element together with the second display element is arranged in a common plane, wherein the first display element can rotate in relation to the second display element. The relative angle of rotation of the first display element in relation to the second display element here corresponds to a relative angle about precisely one axis of the robot link in relation to the gravity vector. Advantageously, this embodiment is intuitively understandable to a user, in particular, if only precisely one angle of the robot link in relation to the gravity vector is relevant.

According to an additional advantageous embodiment, a second angle of the first display element in relation to the second display element corresponds, at each of the plurality of points in time, to an angle about a second axis according to the relative orientation of the robot link in relation to the gravity vector, wherein the first axis and the second axis are perpendicular to one another. According to this embodiment, in contrast to the preceding embodiment, an angle about a second axis is also displayed by the first display element in relation to the second display element.

According to an additional advantageous embodiment, a shift of the first display element in relation to the second display element at each of a plurality of points in time corresponds to an angle about a second axis according to the relative orientation of the robot link in relation to the gravity vector, and an angle of the first display element in relation to the second display element at each of a plurality of points in time corresponds to an angle about a first axis according to the relative orientation of the robot link in relation to the gravity vector.

According to an additional advantageous embodiment, a first shift of the first display element in relation to the second display element at each of a plurality of points in times corresponds to an angle about a first axis according to the relative orientation of the robot link in relation to the gravity vector, and a second shift of the first display element in relation to the second display element at each of a plurality of points in time corresponds to an angle about a second axis according to the relative orientation of the robot link in relation to the gravity vector.

According to an additional advantageous embodiment, the visual output unit is a screen. The screen is preferably a screen of a computer, wherein the computer is separate from the robot manipulator and connected to it only by cable or by radio. Alternatively, the screen is preferably arranged on the robot manipulator itself, particularly preferably on the distal end of the robot manipulator, and more preferably on the robot link or on the end effector of the robot manipulator.

According to an additional advantageous embodiment, the visual output unit is an LED array. The LED array is in particular a sequence of individual LEDs (light emitting diodes), wherein the LEDs are preferably arranged in a row and the magnitude of an angle about an axis according to the orientation of the robot link in relation to the gravity vector correlates with the number of illuminated LEDs on half of the sequence. Advantageously, a visual representation is provided to the user in a very intuitive manner and by technically simple means, showing which angle of the robot link in relation to the gravity vector about the axis in consideration is currently present.

According to an additional advantageous embodiment, the visual output unit is a display which is designed to indicate a numerical value. Preferably, a simple LCD display is used for this purpose. According to an additional advantageous embodiment, the visual output unit is a projector. According to an additional advantageous embodiment, the visual output unit is a laser emitter.

According to an additional advantageous embodiment, the inertial measuring unit is designed to determine the direction of the gravity vector when the robot link is immobile using acceleration sensors. The acceleration sensors are, in particular, translational acceleration sensors, wherein moreover preferably three acceleration sensors are arranged in respectively three axes which are respectively perpendicular to each other in pairs. If, in general, one of three acceleration sensors by nature is not exactly in the direction of the gravity vector, then, via the individual components of the respective acceleration sensors, a direction of the gravity vector can be derived. This occurs preferably via a simple triangle of forces and simple geometric computations.

According to an additional advantageous embodiment, the inertial measuring unit is designed to determine, on the basis of translational accelerations measured with the acceleration sensors and on the basis of a current orientation of the robot link, a current relative position in relation to a position when the robot link is immobile.

Advantageously, according to this embodiment, the user is enabled to determine not only the orientation of the robot link with greater precision via the feedback of the orientation of the robot link in relation to the gravity vector, but also the position of the robot link relative, for example, to a base of the robot manipulator or in relation to a starting position before the manual guidance. This advantageously makes it simple for the user to perform with precision a learning process for the robot manipulator by manual guidance both with regard to the orientation of the robot link in relation to the earth and also with regard to a position of the robot link.

An additional aspect of the invention relates to a method for outputting a current orientation of a robot link of a robot manipulator in relation to the gravity vector on a visual output unit, the method including:
determining a direction of a gravity vector when the robot link is immobile using an inertial measuring unit arranged on the robot link,
determining, over a plurality of points in time, a current orientation of the robot link in relation to the gravity vector using attitude gyros of the inertial measuring unit,
transmitting, from the inertial measuring unit to the visual output unit, the current orientation of the robot link in relation to the gravity vector, and
displaying the current orientation of the robot link in relation to the gravity vector on the visual output unit.

The displaying of the current orientation of the robot link in relation to the gravity vector on the visual output unit occurs in particular online, that is to say in real time in relation to, in particular simultaneously with, the determination of the current orientation of the robot link in relation to the gravity vector.

Advantages and preferred developments of the proposed method result from an analogous and appropriate application of the explanations given above in connection with the proposed robot system.

Additional advantages, features and details result from the following description in which at least one embodiment example is described in detail if applicable in reference to the drawings. Identical, similar, and/or functionally equivalent parts are provided with identical reference numerals.

### BRIEF DESCRIPTION OF THE DRAWINGS

In the drawings:

FIG. 1 is a robot system with a robot manipulator and with a visual output unit according to an embodiment example of the invention;

FIG. 2 is a visual output unit according to an additional embodiment example of the invention; and

FIG. 3 is a method for outputting a current orientation of a robot link of a robot manipulator in relation to the gravity vector on a visual output unit according to an additional embodiment example of the invention.

### DETAILED DESCRIPTION

The representations in the figures are diagrammatic and not to scale.

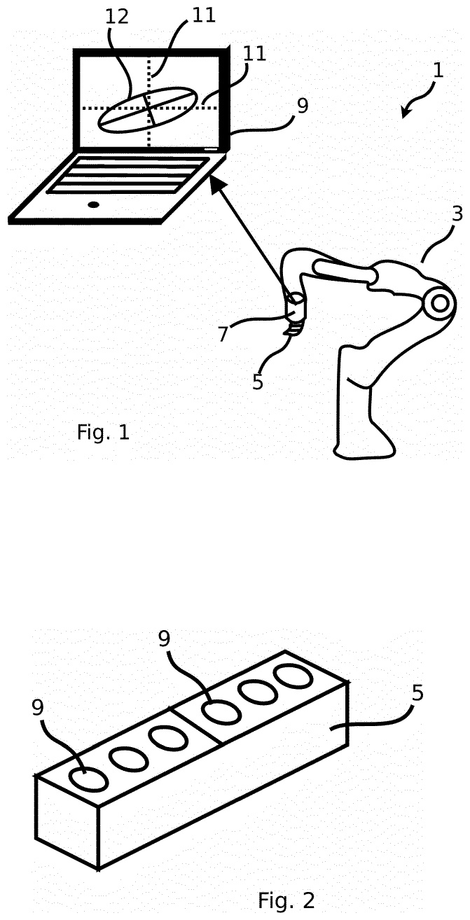

FIG. 1 shows a robot system 1 with a robot manipulator 3 and with a visual output unit 9, wherein the visual output unit 9 is a screen of a mobile computer and the mobile computer is connected for data processing at least to the inertial measuring unit 7. On a distal end of the robot manipulator 3, an end effector which forms the robot link 5 is arranged, and the robot link 5 includes an inertial measuring unit 7. This inertial measuring unit 7 determines the direction of a gravity vector when the robot link 5 is immobile using acceleration sensors and determines, over a plurality of points in time, a current orientation of the robot link 5 in relation to the gravity vector using mechanical attitude gyros, whether the robot link 5 is moving or immobile. The inertial measuring unit 7 transmits, to the visual output unit 9, the current orientation of the robot link 5 in relation to the gravity vector. The visual output unit 9 in turn subsequently displays the current orientation of the robot link 5 in relation to the gravity vector.

The visual output unit 9 includes a first display element 11 in the form of a dotted cross which remains stationary in relation to the screen 9 and consists of two bands positioned perpendicularly to one another. In addition, the visual output unit 9 includes a second display element 12 in the form of a spatially represented circle. A first angle of the first display element 11 in relation to the second display element 12 correlates at a plurality of points in time with an angle about a first axis according to the relative orientation of the robot link 5 in relation to the gravity vector.

If a coordinate system, which is arranged stationary in relation to the robot link 5, is oriented in relation to the gravity vector in such a manner that a longitudinal axis of the robot link 5 correlates with the direction of the gravity vector, that is to say in such a manner that two other axes of the coordinate system lie in a horizontal plane, then the user looks directly into the plane of the circle 12 which then correlates with the horizontal axis of the first display element 11.

In an orientation of the robot link 5 in relation to the gravity vector, which deviates from this case, the circle 12 is accordingly represented by two orientation angles about a respective horizontal axis, wherein the two horizontal axes remain in a horizontal plane in relation to the earth, and the two horizontal axes are perpendicular to one another. Therefore, if the robot link 5 is inclined about a first horizontal axis, then the circle plane on the screen 9 is inclined in relation to the horizontal band of the first display element 11. Furthermore, if the robot link 7 is inclined about the second horizontal axis, then the imaginary viewing angle of the user onto the circle 12 shifts out of the circle plane with an angle onto the circle plane. The circle 12 here is represented in general as a distorted ellipsoid on the screen 9 when the robot link 5 is oriented incorrectly above the horizontal plane and thus in relation to the gravity vector.

FIG. 2 shows a visual output unit 9, wherein the visual output unit 9 is an LED array. Here, only a single angle about precisely one axis of the robot link 5 in relation to the gravity vector is considered. If this angle differs from zero, then, depending on the sign of this angle and correlating with a magnitude of the angle, a left side or the right side of the LED array is illuminated farther to the right or farther to the left, and thus, starting from the midpoint, in the outward direction, a certain number of LEDs are illuminated.

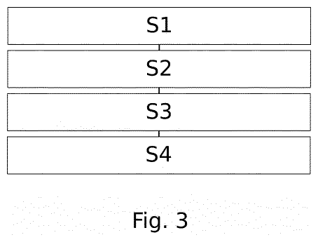

FIG. 3 shows a method for outputting a current orientation of a robot link 5 of a robot manipulator 3 in relation to the gravity vector on a visual output unit 9, the method including:
determining S1 a direction of a gravity vector when the robot link 5 is immobile using an inertial measuring unit 7 arranged on the robot link 5;
determining S2, over a plurality of points in time, a current orientation of the robot link 5 in relation to the gravity vector using attitude gyros of the inertial measuring unit 7;
transmitting S3, from the inertial measuring unit 7 to the visual output unit 9, the current orientation of the robot link 5 in relation to the gravity; and
displaying S4 the current orientation of the robot link 5 in relation to the gravity vector on the visual output unit 9.

Although the invention has been illustrated in detail and explained in detail using preferred embodiment examples, the invention is not limited by the disclosed examples, and other variations can be derived by the person skilled in the art therefrom, without leaving the scope of protection of the invention. Therefore, it is clear that numerous variation possibilities exist. It is also clear that embodiments mentioned by way of example in fact represent only examples, which in no way should be understood to be a limitation of, for example, the scope of protection, the application possibilities or the configuration of the invention. Instead, the above description and the description of the figures enable the person skilled in the art to correctly implement example embodiments, wherein the person skilled in the art, aware of the disclosed inventive idea, can make numerous modifications, for example, with regard to the function or the arrangement of individual elements mentioned in an example embodiment, without leaving the scope of the protection which is defined by the claims and their legitimate equivalents such as, for example, more detailed explanations in the description.

### LIST OF REFERENCE NUMERALS

1 Robot system
3 Robot manipulator
5 Robot link
7 Inertial measuring unit
9 Output unit
11 First display element
12 Second display element
S1 Determining
S2 Determining
S3 Transmitting
S4 Displaying

1. A robot system with a robot manipulator and with a visual output unit, wherein the robot manipulator comprises a robot link and the robot link comprises an inertial measuring unit, wherein the inertial measuring unit is designed to determine a direction of a gravity vector when the robot link is immobile, and to determine, over a plurality of points in time, a current orientation of the robot link in relation to the gravity vector using attitude gyros, and to transmit, to the visual output unit, the current orientation of the robot link in relation to the gravity vector, and wherein the visual output unit is designed to display the current orientation of the robot link in relation to the gravity vector.

2. The robot system according to claim 1, wherein the visual output unit comprises a first display element and a second display element, wherein, at each of the plurality of the points in time, a shift between the first display element and the second display element, a rotation between the first display element and the second display element, or the shift and the rotation correlates with at least one angle about a respective axis according to the relative orientation of the robot link in relation to the gravity vector.

3. The robot system according to claim 2, wherein, at each of the plurality of the points in time, a first angle of the first display element in relation to the second display element correlates with an angle about a first axis according to the relative orientation of the robot link in relation to the gravity vector.

4. The robot system according to claim 3, wherein, at each of the plurality of the points in time, a second angle of the first display element in relation to the second display element corresponds to an angle about a second axis according to the relative orientation of the robot link in relation to the gravity vector, wherein the first axis and the second axis are perpendicular one another.

5. The robot system according to claim 3, wherein, at each of the plurality of the points in time, a shift of the first display element in relation to the second display element correlates with an angle about a second axis according to the relative orientation of the robot link in relation to the gravity vector, wherein the first axis and the second axis are perpendicular to one another.

6. The robot system according to claim 1, wherein the visual output unit is a screen.

7. The robot system according to claim 1, wherein the visual output unit is an LED array.

8. The robot system according to claim 1, wherein the inertial measuring unit is designed to determine the direction of the gravity vector when the robot link is immobile using acceleration sensors.

9. The robot system according to claim 8, wherein the inertial measuring unit is designed to determine, based on translational accelerations measured by the acceleration sensors and based on a current orientation of the robot link, a current relative position in relation to a position when the robot link is immobile.

10. A method for outputting a current orientation of a robot link of a robot manipulator in relation to the gravity vector on a visual output unit, the method comprising:
determining a direction of a gravity vector when the robot link is immobile using an inertial measuring unit arranged on the robot link;
determining, over a plurality of the points in time, a current orientation of the robot link in relation to the gravity vector using attitude gyros of the inertial measuring unit;
transmitting, from the inertial measuring unit to the visual output unit, the current orientation of the robot link in relation to the gravity vector; and
displaying the current orientation of the robot link in relation to the gravity vector on the visual output unit.

11. The method according to claim 10, wherein the method comprises determining, using acceleration sensors, the direction of the gravity vector when the robot link is immobile.

12. The method according to claim 11, wherein the method comprises determining, using the inertial measuring unit, based on translational accelerations measured by the acceleration sensors and based on a current orientation of the robot link, a current relative position in relation to a position when the robot link is immobile.
